(19) United States
(12) Patent Application Publication
(10) Pub. No.: US 2002/0174068 A1
(43) Pub. Date: Nov. 21, 2002

(54) Method for increasing the security of payment of tradesman by a client, corresponding localization center and system

(76) Inventor: Rodolphe Marsot, Grenoble (FR)

Correspondence Address: Robert M. Angus, Westman, Champlin & Kelly, International Centre, Suite 1600, 900 Second Avenue South, Minneapolis, MN, 55402-3319, US

(21) Appl. No.: 10/137,672

(22) Filed: Apr. 29, 2002

(30) Foreign Application Priority Data
May 7, 2001 (FR) FR01 06093

(51) Int. Cl. G06F 17/60

(52) U.S. Cl. 705/39

(57) ABSTRACT

The invention concerns a security method for a payment from a client to a supplier, including a transmission step to a management center of a payment request including at least one identifier of said client, according to a predefined protocol.

Set forth in the invention, such a process includes a validation step wherein:

said management center generates a validation request, to the attention of said client, according to a second protocol independent from said first protocol, to an address indicated by said client;

a transmission is made in the name of said client of a payment validation or refusal message, according to said second protocol.

The field of the invention is the payment of goods and/or services acquired by a client. More specifically, the invention concerns the security of a payment from a client to a supplier, notably if the payment is made by bank card, or by producing a bank card number (for example via the Internet, telephone, or fax).

Since ATM (bank) cards first appeared, many efforts have been made to make bank transactions more secure. These efforts became more intense with the apparition of modern communication networks such as the Internet, and notably since it became possible to make purchases and their corresponding payments through this method.

In fact, these days one need only know someone's bank card number to be able to make transactions in their name, and thereby withdraw fraudulently from their bank account.

Indeed, it is very easy to acquire such a number, as they are sometimes sent at the request of suppliers or service providers. For example, when a client wishes to book a hotel room, the hotel office usually requests the future guest's bank card number, as a way to hold the reservation. Similarly, certain e-commerce Websites request the bank card numbers of their clients and save them for future use.

Today, there is no existing solution to detect fraudulent usage, by a third party, of a bank card number that doesn't belong to them, and more importantly, there is no existing solution to block this type of transaction.

The purpose of the invention is notably to avoid these drawbacks of the prior art.

More specifically, the purpose of the invention is to offer a transaction security technique for more efficient protection for the bank card holder, especially to prevent fraudulent usage by a third party of the bank card number.

Another important purpose of the invention is to set up a transaction security technique that is separate from the transaction itself.

The invention also has the intended purpose of allowing a third party company (for example a telecommunications operator) to suggest setting up a bank transaction security service for final users.

Another intended purpose of the invention is the implementation of a transaction security technique that is simple and inexpensive to set up.

These purposes, as well as others to be described later, are carried out using a client-to-supplier payment security product that includes a step to transmit to the management center according to a predefined first protocol, and a payment request including at least one identifier for said client.

Set forth in the invention, such a method includes a validation step wherein:

said management center manages a validation request for said client, according to a second protocol independent from said first protocol, at an address specified by said client;

a validation or payment refusal message (according to said second protocol) is transmitted in the name of said client.

This way, the invention is based on a totally new and inventive client-supplier payment security approach. Indeed, the invention offers a confirmation mechanism, from the client, for a bank transaction, that is independent from the transaction payment mechanism itself. Notably, such a confirmation mechanism includes an address indicated by the client, which thereby makes any fraudulent transaction by a third party impossible, as the third party only holds the client's bank card number and does not know or cannot access the previously specified address.

According to a preferred embodiment of the invention, said client is equipped with a terminal capable of radio-communication.

Most preferably, said second protocol is the SIP.

More preferably, said validation request is generated as an “INVITE” message.

Favorably, such a method includes the following steps:

(a) receipt, by said management center, of a payment request sent by said supplier;

(b) transmission of a validation request from said management center to a localization server;

(c) identification of a proxy server, on which said client is registered by said localization server;

(d) transmission of said validation request to said proxy server;

(e) transmission by said proxy server of said response to said management center.

This way, for example, the client may assign a script to the proxy server as a way to pre-program it. The responsibility to respond to the validation request received by the management center in the client's name then falls to the proxy server, depending on the previously defined criteria. Validation of the transaction is then made indirectly, by pre-programming the proxy server.

According to an advantageous variation of the invention, such a method further includes, at least in certain situations, on completion of said transmission step of said validation request to said proxy server, the following steps:

(d_{bis}) transmission of said validation request by said proxy server to said client equipped with a terminal;

(dₜₑᵣ) transmission of a response to said validation request by said client equipped with a terminal to said proxy server;

so that said proxy server transmits said response to said management center.

Transaction validation is therefore made clearly by the client, and sets up a terminal held by the latter, to which the proxy server transmits the validation request. Steps d_{bis} and dₜₑᵣ are optional for the invention, and are only set up if the proxy server has not been preprogrammed according to the criteria defined by the client, or under certain conditions programmed by the client.

According to an advantageous feature of the invention, once the client is equipped with a terminal, said steps (e) and (f) set up a transmission using at least one of the techniques from the group which includes:

short messages (SMS);

telephone communications;

electronic messages.

According to an advantageous technique of the invention, said management center and/or said proxy server set up a validation request procedure only in certain pre-determined cases.

One can also anticipate that at the client's request, the management center only requests confirmation for transactions of amounts exceeding a predetermined threshold, as indicated by the client. One can also anticipate that the management center systematically sends out a validation request to the proxy server, but that it only transmits this request to a terminal retained by the client if the transaction meets a certain number of criteria defined by the client.

Most preferably, said particular cases depend on at least one of the following parameters:

transaction amount;

client type;

supplier type;

proxy server type.

This way, the client can indicate to the proxy server, for example in the form of a script, that they do not wish to receive the validation request on a terminal that they hold, for transactions coming from a predetermined list of suppliers, and/or exceeding a predefined amount. The script may of course also define other criteria that should verify the transaction so that a validation request is set up.

Favorably, at least one of the parameters of the said predetermined cases is configurable by at least one of the following interveners:

the client;

the supplier;

the management center;

the proxy server.

More preferably, a response to a validation request can be one of three types:

positive response;

negative response;

absence of response.

According to a preferred feature of the invention, the absence of a response is interpreted by said proxy server and/or by said management center as a negative response.

Indeed, the absence of a response from the client or the proxy server to a validation request sent out by the management center may be due to an error occurring during request and/or response transmission. By interpreting the absence of a response as a negative response, the security of the transaction is thusly increased, by guaranteeing the clients that the payment is not accepted against their wishes.

Favorably, said management center only carries out the entire bank process related to said payment after receiving a positive response to said validation request.

Indeed, it is not useful for the management center to use resources to carry out the bank process, if the client and/or the proxy server refuse(s) the transaction. Of course, one can also envision setting up an alternative of the invention, which would use more resources, wherein the management center carries out the bank process related to the payment, before receiving a response to the validation request.

Said payment is most preferably made using a bank card.

The invention also involves a localization center of at least one client, setting up the previously described method.

A telecommunications operator, who sets up a SIP during the localization step of a proxy server specified by a client, for example manages such a localization center.

The invention also involves a payment security system between a plurality of clients and a plurality of suppliers, which sets up a localization server capable of receiving validation requests from at least one management center from which a payment was required, of transmitting said validation requests to terminals held respectively by each of said clients, and of receiving and passing on a response to said validation request, sent by said client using their terminal.

Other features and advantages of the invention appear more clearly when reading the following description of a preferred embodiment, given by way of simple explanatory and non-restrictive example, and the attached drawings, among which:

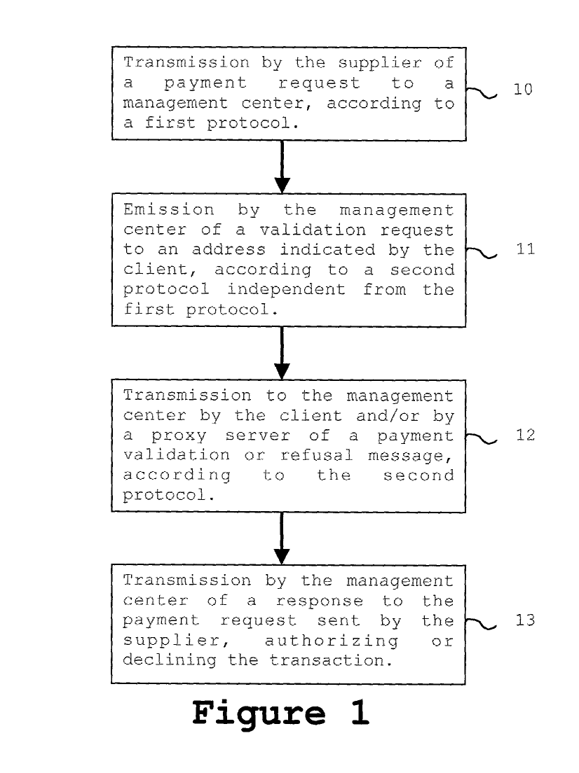

FIG. 1 shows a general view of the different implementation steps during the payment security process according to the invention;

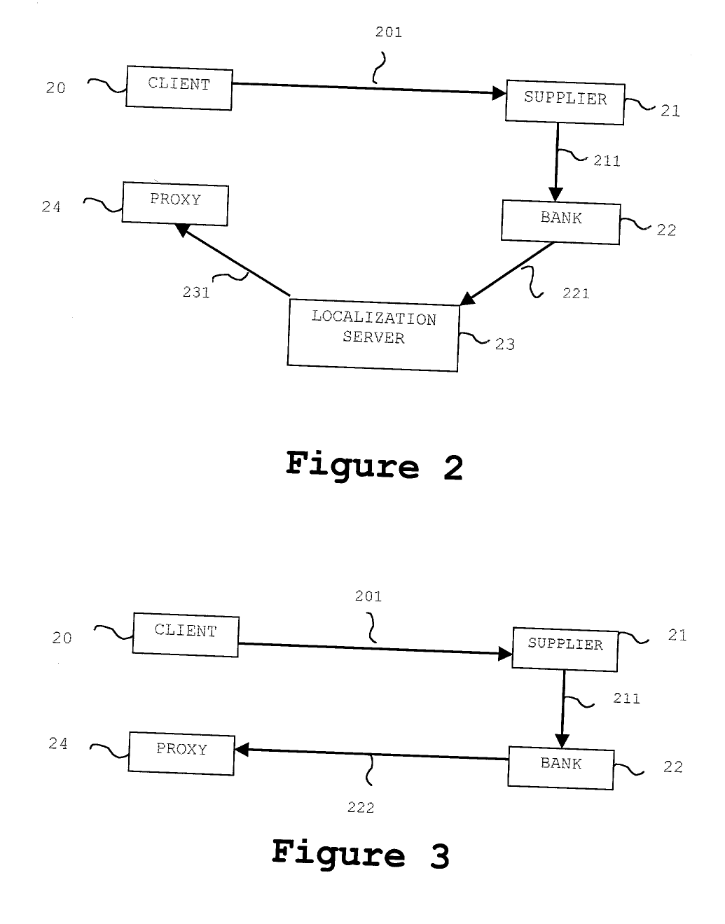

FIG. 2 illustrates a first embodiment for steps 10 and 11 of FIG. 1;

FIG. 3 describes a second embodiment for steps 10 and 11 of FIG. 1, which constitutes an alternative to the mechanism in FIG. 2;

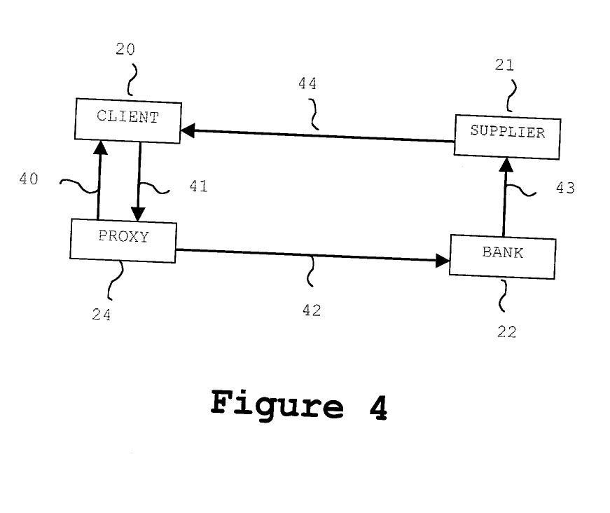

FIG. 4 is an example of the embodiment of steps 12 and 13 of FIG. 1.

The main principle of the invention is based on setting up a transaction confirmation mechanism, independent from the transaction management mechanism itself, while having a terminal held by the client intervene.

In relation to FIG. 1, an embodiment of the invention's payment security method is presented.

By way of example, the invention set up is described in the context of a purchase made by a client from a supplier, using a bank card, and for which the payment confirmation is made using the client's mobile radiocommunication telephone.

Of course, the invention can also be applied to every other type of purchase, such as a purchase made by the client on an Internet website, or even a mail-order purchase. The payment confirmation mechanism proposed by the invention can also use every other type of terminal held by the client, such as, for example, a telephone (non-mobile), a portable computer, a PDA (Personal Digital Assistant), etc.

For example, a client wishes to acquire goods from a supplier, and pays for his/her purchase using a bank card. The supplier then inserts the client's bank card into the appropriate reader. Generally, a verification phase is then launched, wherein the client is asked to enter for example a secret PIN (Personal Identification Number) or code (the secret code for their bank card). For a purchase over the worldwide Internet network, the client verification phase generally involves their entering a password instead of a PIN code.

During step 10, the supplier then communicates with the management center (the client's bank, or an organization such as “GIE Carte Bancaire™”) to transmit a payment authorization request.

According to the techniques known in prior art, the management center then returns a confirmation code to the supplier if the client's bank card is valid, and if the bank account contains sufficient funds. The supplier then authorizes the client's purchase, which concludes the transaction. However, a third party with criminal intentions may have used the card or the number of the client's account, against the wishes of the latter.

However, according to the invention, the management center sends out a validation request during step 11 intended for example for a terminal held by the client. Such a request can also be addressed, during step 11, to a proxy server, to an address indicated by the client. According to a preferred inventory embodiment, step 11 is set up before the management center verifies the validity of the client's bank card and the status of their bank account. Such a step 11 can of course also be set up once the management center has moved forward with verification (in all or in part).

For example, during step 11, the client's bank composes a request according to a SIP type protocol, intended for an application that shows the client. Such a request is received by the client on their mobile phone, and/or processed by a proxy server to which the client has assigned responsibility to process and respond to the request sent out by the bank.

According to a preferred alternative of the invention, during step 11, the request sent out by the bank is directed to a proxy server, as defined by the SIP localization server. This way, even if the client cannot be reached, a decision can be made by default by the proxy server. Another advantage of sending the request to a proxy server and not directly to a terminal held by the client is that one can then give a third party company the responsibility to contact the client for confirmation (for example, by a simple telephone call, by an SMS, or by another method that the client has selected to be reached in such a situation).

Below, the SIP features are recalled, which are implemented in a preferred embodiment of the invention. SIP is an acronym for “Session Initiation Protocol”, which is the IETF (“Internet Engineering Task Force”, the organization that defines RFC or “Request for Comments” standards) standard described in the referenced document RFC 2543. SIP is a protocol intended to manage (i.e. establish, modify, and end) communication sessions between one or more parties.

A SIP allows, among other things, a session negotiation phase. When establishing a session, a dialog is set up between user terminals in order to determine the best mode of communication. The session then continues during the entire connection.

More specifically, according to the SIP, a caller can send an invitation, INVITE, to the recipient's address. Once they receive this message, the recipient can accept, refuse, or transfer the communication.

If the message is accepted, the recipient sends a positive message back, indicating the medium or media to use to reach them during the session, including the corresponding address(es) and/or number(s).

In an INVITE message, or in the following messages, the user information (as is the case for the Integrated Services Digital Network, ISDN) can include additional information (for example, a URL (Uniform Resource Locator), a Web page, or a request for an appointment).

According to a first alternative of the invention, in response to the validation request sent out by the management center, the client transmits (12) to the latter a validation or payment refusal message, according to the same protocol than the one used during the preceding step 11, via their mobile phone. A predetermined time lapse can be planned for this operation.

According to a second alternative of the invention, the validation request can be processed indirectly, by the proxy server, without client intervention. The indirect transaction validation method used by the proxy server may then implement:

a predefined client profile: the proxy server then adapts the transaction processing to the profile of the client. For example, the proxy server systematically transmits the validation request to new clients, to a terminal that they hold. The proxy server may also refuse payment for all transactions for the clients overdrawn accounts, as signaled by the management center;

a generic script: the proxy server then adapts the transaction processing to the parameters of this transaction. For example, a maximum transaction amount per day or per supplier is defined, and when this amount is reached, the proxy server systematically refuses to validate the transaction;

a script customized by the client: the client indicates to the proxy server the criteria that the transaction should verify before deciding whether or not to accept payment.

Depending on the message sent out (11) by the client, and possibly depending on the results of the previously mentioned bank card validity and account status checks, the management center transmits (13) to the supplier a response to their payment request, in order to authorize or unauthorize the transaction. Step 13 sets up a classic protocol, identical to the one set up during the initial step 10, but different from the protocol (for example, the SIP) used for intermediary steps 11 and 12.

Now, in relation to FIG. 2, a first alternative of the detailed embodiment of steps 10 and 11 in FIG. 1 is presented.

During step 201, client 20 indicates their purchase to supplier 21. Step 201 can be set up through a bank card reader, or by leaving the bank information on a network (such as the Internet), or by placing an order with a supplier 21 (or a site) already in possession of the bank information of client 20.

Supplier 21 then sends (211) a payment request to the bank 22 of client 20. Such a request consists of a payment authorization request, and can also carry an authorization request of client 20. It includes, for example, the bank card number and expiration date of the client 20, the amount of the purchase, identification data of supplier 21, and the name of client 20.

The bank 22 then composes (221) a SIP type request intended for an application that shows client 20. This request is generated using information received from supplier 21 during step 211, and is for example sent to a SIP type address, in the format of cardnumber@BC.com, for example 123245678888@GIE-carte-bancaire.com. If the bank 22 sets up a SIP type protocol during step 221, the validation request is sent out in the form of an INVITE type message. The additional data are then included in the field reserved for user data in a MIME message (“Multipurpose Internet Mail Extension”).

The localization server 23 (for example the localization server “GIE-carte-bancaire”) receives the validation request from bank 22, and redirects it to a proxy-type application server 24, wherein the client 20 has selected to execute the confirmation service logic. The validation request can for example be sent to an address such as client@vizzavi.com (™).

When using a SIP type protocol for the validation request, proxy 24 is the server on which client 20 is saved.

FIG. 3 illustrates a second embodiment alternative detailed in steps 10 and 11 in FIG. 1, which differs from the preceding alternative presented in relation to FIG. 2 in that the validation request is sent (222) by the bank 22 directly to the proxy 24, without going through a localization server 23.

During steps 231 and 222, the initial address (type cardnumber@BC.com) to which the validation request is addressed may have changed to an address linked with the client (for example Jean.Dupont@cegetel.fr (™) ). In the alternative illustrated in FIG. 3, such an address is for example linked with the client's bank card number in a client database at the bank. The message retains the same user data.

The processing phase linked with steps 12 and 13 in FIG. 1 is now presented with FIG. 4.

Proxy 24 sends (40) to client 20 a confirmation request generated from the validation request sent by bank 22. Such a confirmation request can for example be transmitted in the form of a short SMS type message, a telephone call, of a call sent to the computer of the client 20. For example, one can envision sending a confirmation request in the form of a SIP message, WAP push, or Instant Message.

According to a preferred embodiment of the invention, client 20 receives the confirmation request on his/her mobile phone.

Client 20 sends (41) a response to proxy 24 that may or may not authorize the considered transaction. One can also imagine that client 20 doesn't respond to proxy 24; the absence of such a response would be interpreted (after a predetermined maximum waiting time) as a negative response by proxy 24.

Proxy 24 then sends (42) the response of the client 20 to bank 22, for example in the form of an INVITE type message indicating authorization or refusal of the transaction by the client, as well as their identifier.

Upon receipt of a positive response, bank 22 sets up a classic bank transaction process. Notably, bank 22 can verify that the bank account 22 of the client contains sufficient funds. Depending on the results of this bank process, bank 22 sends (43) to supplier 21 a message authorizing or refusing the transaction, according to a classic protocol of the same type used to send (211) the payment request.

However, upon receipt of a negative response, bank 22 sends (43) directly to supplier 21 a negative response to the payment request sent by the supplier during step 211, according to the same protocol than the one used for this request.

Such a response from bank 22 appears for example on the bank card reader of the supplier 21.

Response 43 from the bank may be accompanied by an authentication method, used for example by supplier 21 to verify whether or not the message they receive was indeed sent from an organization that is entitled to send payment authorizations. The authentication of the supplier 21 of the organization, which accepted the transaction, is not specific to the invention, but is generally included in the classic bank transaction validation mechanism.

Supplier 21 can then authorize or refuse (44) the current transaction of the client 20, depending on the response received from bank 22.

Here we have described an embodiment of the invention wherein the proposed confirmation mechanism is systematically set up, for every transaction made by client 20.

Of course, it is possible to imagine embodiment alternatives wherein default logic is applied to the invention. One can also imagine that bank 22 or proxy 24 maintain updated configuration tables wherein client 20 profiles are listed, and which indicate, for example, for each of them the minimum transaction amount from which the invention confirmation mechanism should be set up. These tables can also save the identity of certain suppliers, or certain transaction geographical zones, or even certain transaction types (for example transactions made over the Internet) for which client 20 wishes to implement the invention's confirmation mechanism.

This way, client 20 can indicate to bank 22 that they hope that the bank will request a payment confirmation for all transactions in an amount greater than or equal to 100 [symbol] , unless if they come from certain suppliers 21 of their choice. They can also indicate to bank 22 that they wish to implement the confirmation mechanism for all transactions in which a supplier from a given geographical area (for example for all transactions made abroad) intervene, regardless of the amount.

It should be noted that the amount of 100 [symbol] indicated by way of example above is a threshold above which the initial SIP request is systematically sent. However, this threshold alone isn't enough to secure transactions made by the client, who may be the victim of a plurality of small fraudulent debits from their account, in amounts less than this threshold. It is therefore important, for optimum security, to define a plurality of criteria, which will trigger the sending of a SIP request.

It is also planned that proxy 24 presents a configuration interface through which client 20 can access and modify (if needed) their profile parameters or information in the configuration table.

Client 20 can also indicate one or more criteria to the company managing proxy 24 in order to trigger a validation request that is more direct than indirect. When a transaction verifies this (these) criteria, proxy 24 then systematically requests confirmation from the client, through a terminal, which they hold. Only one site should be updated when the client hopes to modify criteria linked with their profile, contrary to the embodiment alternative previously explained, wherein the client should notify all banks worldwide that process bank card requests of this criteria change.

A third party company may operate proxy 24, which is a central point for each client, and which is therefore easy to manage.

1. Security method for payment from a client to a supplier, including a step wherein a payment request including at least one identifier of said client is transmitted to a management center, according to a previously defined protocol,
characterized in that it contains a validation step according to which:
said management center manages a validation request, to the attention of said client, according to a second protocol independent from said first protocol, to an address indicated by said client;
a message of payment validation or refusal is transmitted in the name of said client, as set forth in the second protocol.

2. Security method according to claim 1, characterized in that said client is equipped with a terminal that possesses means of radio-communication.

3. Security method according to claim 1 or 2, characterized in that said second protocol is the SIP protocol.

4. Security method according to claim 3, characterized in that said validation request is managed in the form of an “INVITE” message.

5. Security method according to any of claims 1 through 4, characterized in that they include the following steps:
(a) receipt, by said management center, of a payment request sent by said supplier;
(b) transmission of a validation request from said management center to a localization server;
(c) identification of a proxy server wherein said client is saved, by said localization server;
(d) transmission of said validation request to said proxy server;
(e) transmission by said proxy server of said response to said management center.

6. Security method according to claim 5, characterized in that it further includes, after said transmission step of said validation request to said proxy server, the following steps among others:
(dbis) transmission by said proxy server of said validation request to said client equipped with a terminal;
(dter) transmission by said client equipped with a terminal of a response to said validation request, to said proxy server;
such that said proxy server transmits said response to said management center.

7. Security method according to claim 6, characterized in that when the client is equipped with a terminal, said steps (dbis) and (dter) set up a transmission using at least one of the techniques from a group that includes:
short messages (SMS);
telephone communications;
electronic messages.

8. Security method according to any of claims 1 through 7, characterized in that said management center and/or said proxy server set up a validation request procedure only in predetermined cases.

9. Security method according to claim 8, characterized in that said predetermined cases depend on at least one of the following parameters:
transaction amount;
client type;
supplier type;
proxy server type.

10. Security method according to any of claims 8 and 9, characterized in that at least one of the parameters of said predetermined cases are configurable by at least one of the following interveners:
the client;
the supplier;
the management center;
the proxy server.

11. Security method according to any of claims 1 through 10, characterized in that a response to a validation request may be one of three types:
positive response;
negative response;
absence of a response.

12. Security method according to claim 11, characterized in that the absence of a response is interpreted by said proxy server and/or by said management center as a negative response.

13. Security method according to any of claims 1 through 12, characterized in that said management center only executes all bank processing related to said payment after receiving a positive response to said validation request.

14. Security method according to any of claims 1 through 13, characterized in that said payment is made using a bank card.

15. Localization center of at least one client, that sets up the process according to any of claims 1 through 14.

16. Security method for payments amongst a plurality of clients and suppliers, characterized in that it sets up a localization server, capable of receiving validation requests from at least one management center from which a payment was required, of transmitting said validation requests to terminals held respectively by each of said clients, and of receiving and passing on a response to said validation request, sent by said client using their terminal.
